(19) United States
(12) Patent Application Publication
(10) Pub. No.: US 2019/0004743 A1
(43) Pub. Date: Jan. 3, 2019

(54) FRAMEWORK FOR REDUCING TONER UTILIZATION BY CONTROLLING TONER INTENSITY

(71) Applicant: Xerox Corporation, Norwalk, CT (US)

(72) Inventors: Sudhagar SUBBAIAN, Coimbatore (IN); Sainarayanan GOPALAKRISHNAN, Chennai (IN); Dhanasekar ANNAMALAI, Chennai (IN)

(21) Appl. No.: 15/637,281

(22) Filed: Jun. 29, 2017

(51) Int. Cl. G06F 3/12; G06K 15/12

(52) U.S. Cl. CPC G06F 3/1204; G06K 2215/0074; G06K 15/128; G06K 15/1223

(57) ABSTRACT

Disclosed is a method, system, and program for reducing toner in an image comprised of raster pel data. A toner saving tag (TST) can be embedded that causes a printing apparatus to process the submission through a regular print path without any post-processing and to reduce toner usage by controlling the energy applied to a light emitting source to create a latent image on a photoreceptor. Further, the method and system applies under certain circumstances both post-processing toner saving mode using pixel elimination and toner saving mode that controls the energy applied to create the latent image while maintaining pixel integrity.

This invention relates generally to machines having print engines such as printers and/or copier devices and, more particularly, to an image forming apparatus with logic that reduces toner usage in print output.

### BACKGROUND OF THE INVENTION

Conventional digital reprographic systems receive electronic image(s), which are passed to an image-processing unit. The image-processing unit may be a combination of software and hardware elements that accepts the electronic images from different sources and performs operations needed to convert the images to the format compatible with the output path of the digital reprographic system.

An aptly programmed hardware element, generally known as a raster image processor, converts the image in a page description language (PDL) or vector graphics format (VGF) to a bit mapped image indicating a value to print at each pixel of the image. Each bit representing a pixel that is “on” is converted to an electromagnetic pulse. The electromagnetic pulses generated from the raster pel data at which to deposit toner turns the laser beam on to positively charge the surface of a rotating drum that has a coating capable of holding an electrostatic charge. The laser beam turns on and off to beam charges at pixel areas on a scan line across the drum that will ultimately represent the output image. After the laser beam charges all pels on the scan line indicated in the raster data, the drum rotates so the laser beam can place charges on the next scan line. The drum with the electrostatic positive charges then passes over negatively charged toner. The negatively charged toner is then attracted to the positive charged areas of the drum that form the image. The print media, which is negatively charged, passes over the roller drum and attracts the toner as the areas of the roller drum with the toner are positively charged to transfer the toner forming the image from the roller drum to the print media.

The current toner savings methods can be broadly classified into the following categories: reducing halftone frequency; adjusting tone reproduction curve (TRC); using neighborhood processing; reducing the charge area that forms the pel on the drum; and, optimizing print engine and image output terminal (IOT) components for better toner yields. Most of these toner saving methods are implemented as post-processing, i.e., after the image has been generated. All of the above mentioned methods have significant impact on the image quality. Some of these methods achieve savings by trading the quality of output by reducing the number of pixels that form the image.

For the above reasons, there is a need in the art for an improved technique to reduce toner in an image in a manner that does not unduly degrade the quality of the image.

### BRIEF SUMMARY OF THE INVENTION

Accordingly, an improved system and method is provided for reducing the amount of toner applied to a print media in print and copy jobs. A processor determines if a command, as a tag in the received job or as a signal, indicates that toner saving is to be applied to the print output. Overall toner usage is reduced by decreasing the energy applied by the light source that creates the latent image on a photoreceptor. Energy reduction is accomplished by modifying the settings in a storage device used to control the on/off cycle of the light source. Additional toner saving can be realized through intelligent halftoning of images that form the print job.

### BRIEF DESCRIPTION OF THE DRAWINGS

FIG. 1 is an exemplary diagram of an image production device in accordance with one possible embodiment of the disclosure;

FIG. 2 is a schematic illustration of an exemplary scorotron charge device which may be used in the system of FIG. 1;

FIG. 3 is a partial schematic elevational view of an example of a digital imaging system, including a print engine, which can employ the toner saving feature of the present invention;

FIG. 4 is a is a flow chart illustrating the work flow of a toner saving feature in a printing system in accordance to an embodiment;

FIG. 5 is a block diagram of toner reduction logic in accordance to an embodiment; and,

FIG. 6 is a flowchart of a method for processing a toner saver tag to update the register/NVM value responsible for controlling energy applied to an imaging member in accordance to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

In accordance with an embodiment of the invention, there is provided two approaches to reducing the amount of toner applied to paper for print an copy jobs: When user submits the job, if toner saver is desired, overall toner usage is reduced by reducing the energy applied to light source, usually as a light emitting diode (LED) or laser, to create latent image by modifying the laser energy NVM setting in the form of a lookup table (LUT); and, when user submits a job, if toner saver is desired, overall toner usage is reduced by reducing the energy applied and the traditional toner-saver that is achieved through intelligent halftoning will also be applied.

Techniques in accordance with the present disclosure may advantageously improve performance and reliability of image output terminals with considerable toner saving and with high image quality in print output.

Illustrative examples of the devices, systems, and methods disclosed herein are provided below. An embodiment of the devices, systems, and methods may include any one or more, and any combination of, the examples described below.

In one aspect, a first example includes a method for reducing toner consumption in a printing system comprising the use of a storage unit with an output value for different patterns of pixel data, where each output value indicates a pulse width power to charge a region of an image bearing member at the printing system; receiving a print job into the printing system comprising a processor, the processor being specialized for processing image data, the print job comprising an image; sensing whether a tag that represents a toner saving mode is embedded in the image; in response to the embedded tag, then automatically updating the output value for different patterns of pixel data in the storage unit; and controlling an exposure device using the output value for different patterns of pixel data in the storage unit to create at least one latent image at the image bearing member.

According to a second example that includes the first example and wherein the receiving the print job further comprises receiving a PDL file; parsing the PDL file; and identifying embedded coded symbology from the PDL file.

According to a third example that includes the second example and wherein the output value is an exposure time or luminous energy of the exposure device.

According to a fourth example that includes the third example and wherein the tag is at least one of a barcode, a glyph, text, an image, and coded symbology.

In another example wherein controlling the exposure device reduces applied energy to create the at least one latent image while maintaining number of pixels of the received image.

In yet another example that includes the first example and wherein the controlling is performed by a pulse controller connected to the storage unit to control a pulse width of a laser scanning unit to adjust the energy applied to the image bearing member.

Example 7 includes example 6 and further comprises in response to the embedded tag, then automatically applying toner saving post-processing to the print job.

Example 8 includes example 7 and wherein applying toner saving post-processing is scaling and generating a mask for a selected level of toner saving on the image to produce a resultant image.

In still another example, using the resultant image and the output value in the storage unit to create the latent image at the image bearing member; and, wherein a created latent image from the resultant image requires less pixels than the received image in the print job.

In another aspect, a multifunction device comprising a control system with a processor, said processor comprising a digital image processor; a user interface connected to said control system; and an image output device connected to said processor, said user interface providing user selection of a level of toner savings for said image output device, said processor receiving digitized pixels for an image comprising color planes of different colors, said digitized pixels comprising continuous image data, said digital image processor applying based on user selection post-processing to said digitized pixels of said continuous image data and/or applying based on an indicia on the image a reduction in overall toner usage by lowering the energy applied to create a latent image by: using a storage unit with an output value for different patterns of pixel data, where each output value indicates a pulse width power to charge a region of an image bearing member; sensing whether a tag that represents a toner saving mode is embedded in the image; in response to the embedded tag, then automatically updating the output value for different patterns of pixel data in the storage unit; and controlling an exposure device using the output value for different patterns of pixel data in the storage unit to create at least one latent image at the image bearing member.

In yet another aspect, a non-transitory computer-readable medium storing computer-readable instructions which, when executed by a processor, cause the processor to execute toner consumption reduction in a printing system, comprising displaying user selective levels of toner savings for said printing system at a user interface connected to said processor; and using a storage unit with an output value for different patterns of pixel data, where each output value indicates a pulse width power to charge a region of an image bearing member at the printing system; receiving a print job comprising an image, wherein the print job is received as a PDL file; sensing whether a tag that represents a toner saving mode is embedded in the image; automatically updating the output value for different patterns of pixel data in the storage unit in response to the embedded tag; automatically applying based on user selection post-processing to the image in the print job; and controlling an exposure device using the output value for different patterns of pixel data in the storage unit to create at least one latent image at the image bearing member; wherein the output value is an exposure time or luminous energy of the exposure device; wherein the tag is at least one of a barcode, a glyph, text, an image, and coded symbology; wherein the controlling is performed by a pulse controller connected to the storage unit to control a pulse width of a laser scanning unit to adjust the energy applied to the image bearing member; wherein the post-processing is scaling and generating a mask for a selected level of toner saving on the image to produce a resultant image.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of resistors” may include two or more resistors.

Although embodiments of the invention are not limited in this regard, discussions utilizing terms such as, for example, “processing”, “computing”, “calculating”, “determining”, “applying”, “receiving”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “print media” or “substrate” generally refers to a usually flexible, sometimes curled, physical sheet of paper, Mylar material, plastic, or other suitable physical substrate for images, whether precut or web fed.

As used herein, the term “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

As used herein, the term “printing system” encompasses any apparatus, such as a digital copier, digital imaging system, bookmaking machine, ionographic system, electrophotographic system, multi-function machine, and the like, that can perform a print outputting function for any purpose.

The term “electrophotographic system” is intended to encompass image reproduction machines, xerographic system, electrophotographic printers and copiers that employ dry toner developed on an electrophotographic receiver element.

The term “data” refers herein to physical signals that indicate or include information. When an item of data can indicate one of a number of possible alternatives, the item of data has one of a number of “values.” The term “data” includes data existing in any physical form, and includes data that are transitory or are being stored or transmitted. For example, data could exist as electromagnetic or other transmitted signals or as signals stored in electronic, magnetic, or other form. An “image” is a pattern of physical light. An image may include characters, words, and text as well as other features such as graphics. An image may be divided into “segments,” each of which is itself an image. A segment of an image may be of any size up to and including the whole image.

The term “pixel” is the smallest segment or region into which an image is divided in a given system. As used herein, each pixel value is a set of color space coordinates in a “color coordinate form” of an image, the color coordinate form being a two-dimensional array defining the image.

A “memory”, a “storage medium”, or a “storage unit” is a physical medium that can store data. Examples of data storage media include magnetic media such as hard and floppy disks, and magnetic tape; optical media such as laser disks and CD-ROMs; and semiconductor media such as semiconductor ROMs and RAMs like SRAM.

An “image input terminal” (IIT) is a device that can generate or receive an image and provide an item of data defining a version of the image. An IIT can include a multifunction device, a copier, a fax machine, a scanner, or a printer, for example. A “scanner” is an image input device that receives an image by a scanning operation, such as by scanning a document. Other image input terminals include facsimile (fax) machines, computer graphic workstations, and copiers.

An “image marking engine” (IME) or “image output terminal” (IOT) is a device that can receive an item of data defining an image and provide the image as output. A “display” is an image output device that provides the output image in human viewable form and a “printer” is an image output device that renders the image on a print media or substrate in human viewable form. The visible pattern presented by a display is a “displayed image” or simply “image.”

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

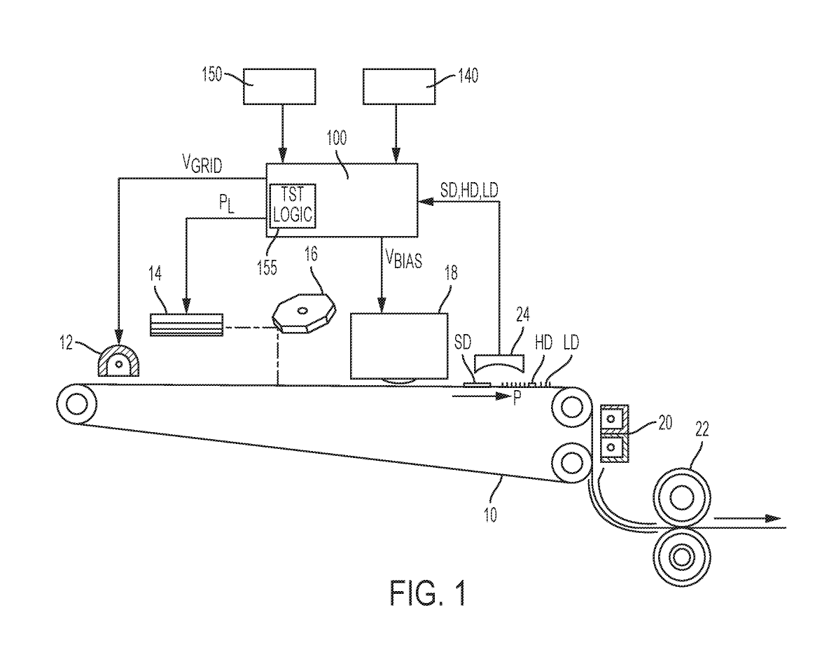

Having thus outlined several embodiments of printing apparatus and processes, and described various sequences of operation, reference is now made to FIGS. 1-6 showing further embodiments. Unless otherwise noted, elements similar to those previously described have been given the same reference numerals and serve the same functions.

FIG. 1 is an exemplary diagram of an image production device in accordance with one possible embodiment of the disclosure. The image production device may be any device capable of making image production documents (e.g., printed documents, copies, and the like) including a copier, a printer, a facsimile device, and a multi-function device (MFD), for example.

The image production device may also include a local user interface 150 for controlling its operations, although another source of image data and instructions may include any number of computers to which the printer is connected via a network.

If the image production device is operable as a copier, the device further includes a document feeder 140 such as a raster input scanner (RIS), which operates to convert signals from light reflected from original hard-copy image into digital signals, which are in turn processed to create copies with an image output terminal (JOT).

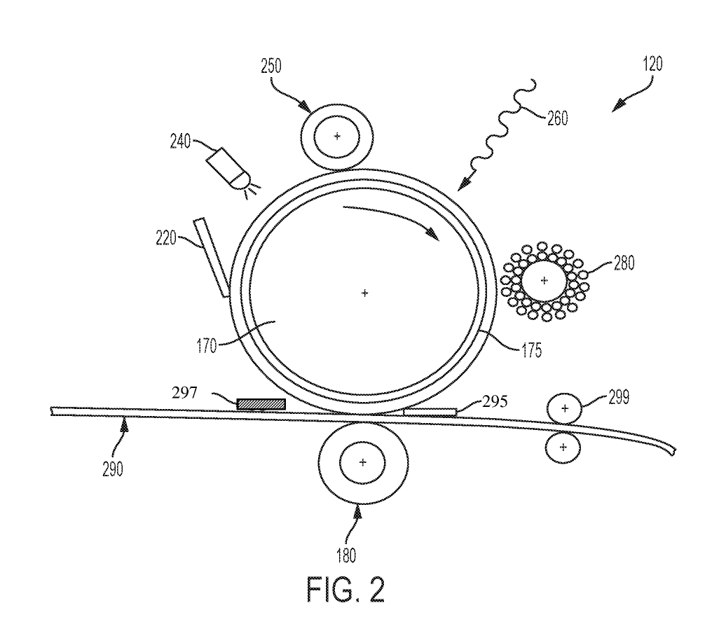

FIG. 1 shows the basic elements of the well-known system by which an electrophotographic printer, generally known as a “laser printer,” uses digital image data to create a dry-toner image on plain paper. There is provided in the printer a photoreceptor 10, which may be in the form of a belt or drum, and which comprises a charge-retentive surface. The photoreceptor 10 is here entrained on a set of rollers and caused to move through process direction P. Moving from left to right in FIG. 1, there is illustrated the basic series of actions by which an electrostatic latent image according to a desired image to be printed is created on the photoreceptor 10, how this latent image is subsequently developed with dry toner, and how the developed image is transferred to a sheet of plain paper. The first action in the electrophotographic process is the general charging of the relevant photoreceptor surface. As seen at the far left of FIG. 1, this initial charging is performed by a charge source known as a “scorotron,” indicated as 12 and 250 in FIG. 2. The scorotron 12 typically includes an ion-generating structure, such as a hot wire, to impart an electrostatic charge on the surface of the photoreceptor 10 moving past it. The charged portions of the photoreceptor 10 are then selectively discharged in a configuration corresponding to the desired image to be printed, by a raster output scanner or ROS, which generally comprises a laser source 14 and a rotatable mirror 16 which act together, in a manner known in the art, to discharge certain areas of the charged photoreceptor 10. Although the Figure shows a laser source to selectively discharge the charge-retentive surface, other apparatus that can be used for this purpose include an LED bar, or, conceivably, a light-lens system wherein the light intensity is readily controllable; as used in the claims herein, such a device is indicated as an exposure device or “exposer.” The laser source 14 is modulated (turned on and off) in accordance with digital image data fed into it, and the rotating mirror 16 causes the modulated beam from laser source 14 to move in a fast-scan direction perpendicular to the process direction P of the photoreceptor 10. The laser source 14 outputs a laser beam having a specific power level, here shown as P_{L}, associated therewith.

After certain areas of the photoreceptor 10 are discharged by the laser source 14, the remaining charged areas are developed by a development unit such as 18 causing a supply of dry toner to contact the service of photoreceptor 10. In the present example, which shows “discharge-area development,” the toner 18 will adhere only to those areas on the photoreceptor 10 which do not have a significant electrostatic charge thereon. The developed image is then advanced, by the motion of photoreceptor 10, to a transfer station including a transfer scorotron such as 20, which causes the toner adhering to the photoreceptor 10 to be electrically transferred to a print sheet, which is typically a sheet of plain paper, to form the image thereon. The sheet of plain paper, with the toner image thereon, is then passed through a fuser 22, which causes the toner to melt, or fuse, into the sheet of paper to create the permanent image.

Some of the system elements of the printer shown in FIG. 1 are controlled by a control system 100, the operation of which will be described in detail below. As used in the claims herein, the term “processing stations” shall apply to any unit which affects the application of toner to the photoreceptor, such as (but not limited to) scorotron 12, laser source 14, or development unit 18. As shown in the Figure, a densitometer generally indicated as 24 is used after the developing step to measure the optical density of a halftone test patch (marked HD), a light test patch (marked LD), and a solid test patch (marked SD) created on the photoreceptor 10 in a manner known in the art.

As can be seen in FIG. 1, the system as the whole is indicated by the box 100. The inputs to the control system 100 are given as the measured values of SD, HD, and LD. The outputs of the control system 100 are given as P_{L}, V_{grid}, and V_{bias}, all of which are parameters which can be fairly directly controlled in real time in an electrophotographic printer, by, for example, adjusting a potentiometer operatively associated with, respectively, the laser source 14, corotron 12, or the development unit 18.

Within the control system generally indicated as 100 are control logic like toner saving tag (TST) 155 logic to reduce overall toner usage by reducing the energy applied to light source LED/Laser to create latent image by modifying the laser source NVM setting AND intelligent halftoning, generally known as “post processing.” The word “logic,” as used herein, is intended to mean a program, such as can be embodied in an independent computer or a portion of a computer, which may include the use of look-up tables and other algorithms which are used to respond to certain inputs thereto with certain outputs.

FIG. 2 is a schematic illustration of an exemplary scorotron charge device which may be used in the system of FIG. 1. Unless otherwise noted, elements similar to those previously described have been given the same reference numerals and serve the same functions.

Referring to FIG. 2, there is shown a schematic view of the image production section 120 of exemplary image production device 100. Although the disclosure includes reference to the exemplary embodiments shown in the drawings, it should be understood that many alternate forms or embodiments exist. In addition, any suitable size, shape or type of elements or materials could be used.

As shown in FIG. 2, the image production section 120 may generally include a photoreceptor on fuser roll 170 with a photoreceptor charge transport layer 175 on a radially outer part of the photoreceptor, a blade cleaner 220, a pre-charge erase device 240, a scorotron charge device 250 in the form of biased charging roll, an exposure device 260, a development device 280, and a bias transfer roll 190. Exposure device 260 forms an electrostatic latent image by irradiating photoreceptor charge transport layer 175 with light (LED, Laser, or the like) corresponding to image information, and visualize the latent image as an image by supplying developer, i.e., toner, as a recording material by the use of a developing 280.

During operation, the pre-charge erase device 240 may remove most of the charge remaining on the photoreceptor charge transport layer 175. However, the pre-charge erase device 240 does not necessarily remove all the remaining charge on the photoreceptor charge transport layer 175. Thus, the photoreceptor charge transport layer 175 may retain some charge after passing through the pre-charge erase device 240, even when the pre-charge erase device 240 is operating. A pre-charge electrostatic voltmeter (not shown) may be used to measure the voltage of the photoreceptor charge transport layer 175 after passing through the pre-charge erase device 240, but before passing through the scorotron charge device 250.

The scorotron charge device 250 may operate to charge the photoreceptor charge transport layer 175. A pre-development electrostatic voltmeter (not shown) may measure the voltage of the photoreceptor charge transport layer 175 before passing through the development device 280 that applies marking material such as toner. The bias transfer roll 180 may optionally perform voltage measurements of the photoreceptor charge transport layer 175. The toner image 295 are transferred to output section 130 after being fed through a fusing station, i.e., rolls 170 and 180, by conveyor 290 and roller pair 299. The media are advanced through a fuser station comprising fuser roll 170 and pressure roll 180 resulting in a fused image 297.

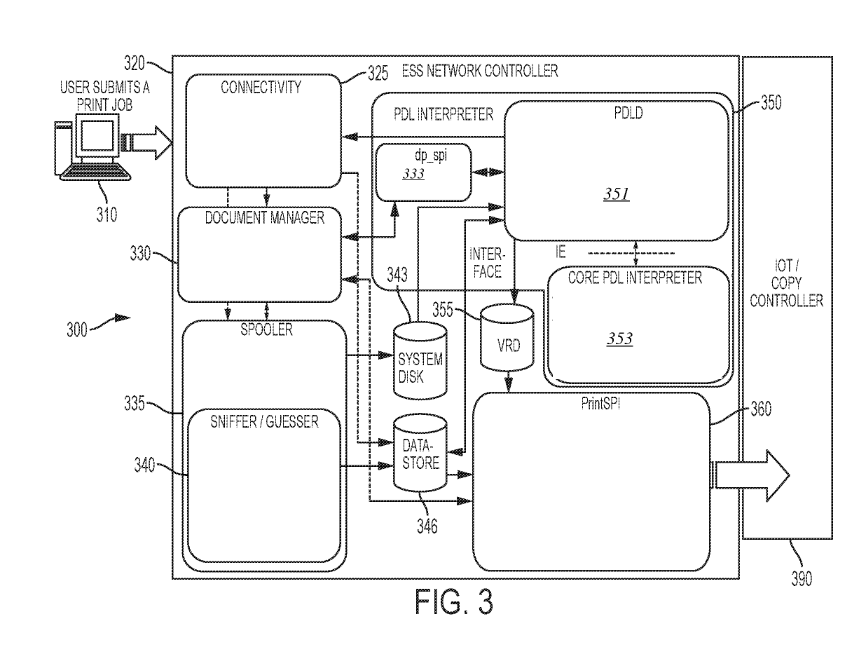

FIG. 3 is a partial schematic elevational view of an example of a digital imaging system 300, including a print engine, which can employ the toner saving feature in accordance to an embodiment. The imaging system 300 is used to produce color output in a single pass of a photoreceptor belt or drum like fuser roll 170 in FIG. 2. It will be understood, however, that it is not intended to limit the embodiment disclosed. On the contrary, it is intended to cover all alternatives, modifications and equivalents as may be included within the spirit and scope of the invention as defined by the appended claims, including a multiple pass color process system, a single or multiple pass highlight color system and a black and white printing system.

In one embodiment, an original document can be positioned on a raster-input scanner (RIS) at a document handler 310 like document feeder 140 to submit a print job. The print job whether from a scanner or from an application is converted into one or more print images suitable for printing. However, other types of scanners may be substituted for capturing the image. The RIS captures the entire original document and converts it to a series of raster scan lines or image signals. The information captured at 310 is transmitted to an electronic subsystem (ESS) 320 or controller. Alternatively, image signals may be supplied by a computer network or computer to ESS 320. An image-processing controller like PDL interpreter 350 receives the document information from a document manager 330 and converts this document information into electrical signals for the raster output scanner like exposure device 260 generally found in image output terminal 390. An image-processing controller generally performs raster image processing (RIPping). Raster image processing is the process of translating the page descriptions (PDL) into a RIPped image or into a bitmap for output by the IOT/IME 390. The ESS 320 elements and other not shown additional elements are well known to those in the art but not shown or described for the sake of brevity. Generally, ESS 320 contains a connectivity element 325, a document manager 330, a spooler 335 with sniffer/guesser 340, a PDL interpreter 350, a system disk 343, data store 346, a storage unit for video ready data (VRD) 355, and a printerspi for sending images and document handling parameters to IOT 390.

The connectivity element 325 manages communication with the network, creates a job with the document manager 330, and stores initial print job attributes. The document manager 325, manages system tasks, schedules print jobs, and select interpreter based on the PDL language. Spooler 325 communicates with the document manager 325, receives data from connectivity 325, and writes the PDL to disk 343 for accessing by PDL interpreter 350. The sniffer 340 which may be part of spooler 335 parses handling parameters such as printer job language (PJL) to datastore 346, and determines the PDL language of the print job. The dp_spi 333 module maintains communication between PDL interpret 350 and document manager 330.

The main elements of PDL interpreter 350 are the PDLD 351 and the core PDL interpreter 353. PDLD 351 reads the PDL from disk 343, reads the document handling parameter from datastore 346, writes images to VRD 355, writes document handling parameters to datastore 346, and sends parameters to connectivity 325. Core PDL interpreter 353 generates images and document handling parameters from the portable document language.

The PrintSPI 360 communicates the document manager 330, read the document handling parameters from datastore 346, reads images from VRD 355, creates a job to the IOT/copy controller 390 and sends images and documents handling parameters to the IOT/copy controller 390 for printing.

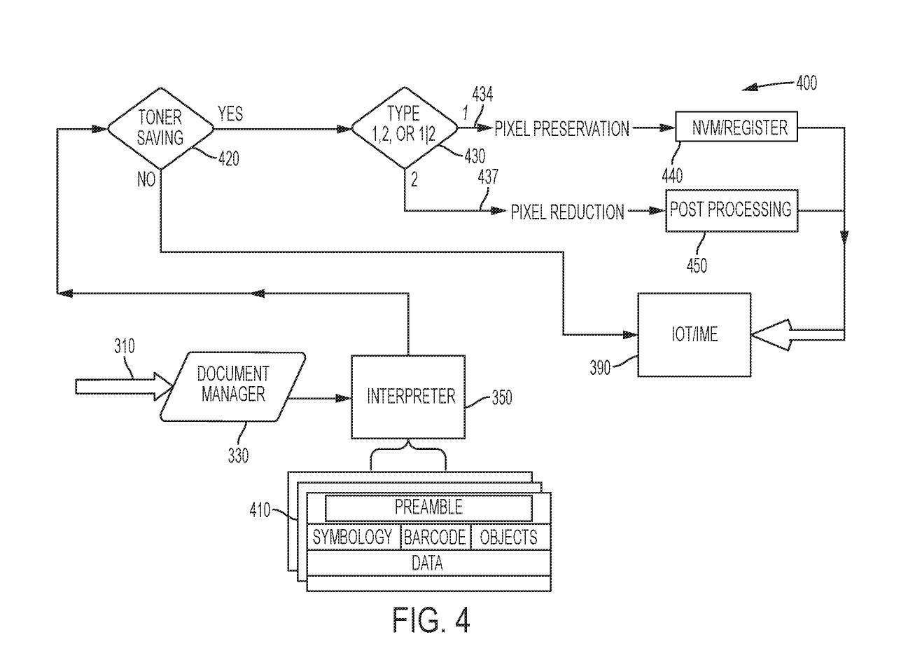

FIG. 4 is a flow chart illustrating the work flow of a toner saving feature in a printing system in accordance to an embodiment. The illustrated toner saving work flow 400 meets the need in the art for toner saving, such as reduction in the number of toner particles, with minimal pint quality. Workflow 400 illustrates two different approaches or framework for reducing the toner utilization. The basic idea behind of the approach is taking the advantage of photographic working principle to achieve our goal. In a first approach, when a user submits a print job the request to print goes through the regular print path without any post-processing, in this case control of toner usage is implemented by controlling energy applied to create the latent image at the photoreceptor layer. See path 434 of the workflow. In a second approach, when a user submits the print job, it goes through the regular toner saving mode (path 437 of the workflow) in addition to controlling energy applied to create latent image like path 434 of the workflow.

As shown in FIG. 4, toner saving workflow 400 begins with a print job submitted by an input source such as from document handler 310. Document manager 330 will identify the corresponding page description language (PDL) interpreter by the help of spooler and sniffer units (335 and 340 at FIG. 3). Once the PDL is identified, document manager 330 will submit the job to specific interpreter. Interpreter 350 identifies the toner saver tag 420 then updates 434 the register values 440 in a lookup table such as a non-volatile memory (NVM). A register value is used to control the energy that is applied by exposure device 260 such as a light source like a light emitting diode (LED) or Laser.

In FIG. 4, the toner saver tag is shown on RIPped image 410. The toner save tag can be embedded in the document forming the print job at the image input terminal, during the creation of the document, at the document manager, or by a signal trigger by the system when there is a need to save toner or by a user using the local user interface like interface 150. On the document the toner saver tag, like shown on RIPped image 410, can comprise data encoding techniques like 1D and 2D barcodes, magnetic ink character recognition (MICR), optical character recognition (OCR), optical mark recognition (OMR), data glyphs, user defined barcode, a glyph, text, an image, coded symbology, and other user defined tags. Differentiating between tags is used to apply to control toner usage by controlling energy applied to create latent image, illustrated as path 434, and/or a regular toner saving mode such as post-processing illustrated as path 437.

Interpreter 350 performs identification processing 420 to determine if a toner saving tag has been identified in the image. When the determination is “NO”, the print job or the image is forwarded to the IOT/IME 390 for rendering first as a latent image on the photoreceptor and then as a print output. If a toner saver tag has been identified then a determination 430 is made as to the type of toner saving that is to apply. A first type of toner saving aims at pixel preservation 434 by updating the register/NVM 440 values. The register values at NVM 440 are then used by IOT/IME 390 to control the energy applied to an exposure device which is commonly a light source LED/Laser. Controlling the energy applied causes a latent image potential on the photoreceptor charge transport layer 175 to change the exposure potential thus changing an amount of toner consumption. A second type of toner saving uses pixel reduction 437 by applying post processing (450) to the RIPped image (410) resulting in removal of some pixels through a process such as halftoning. Fewer pixels lead to a reduction in toner usage and a reduction in image quality. In contrast, toner saving through pixel preservation maintains the number of pixels of the image and only discernible difference from the original is in the developing/back contrast of the output print.

A more aggressive type of toner saving combines both pixel reduction and energy reduction. Determination 430 select toner saving that includes pixel preservation 434 and pixel reduction 437. In this instance, interpreter 350 identifies the toner saver tag and based on the tag it apply toner saver post processing (450), at the same time it will update register/NVM value (440). Application of both toner saver with post processing and toner saver with low energy result in double the saving in marking material.

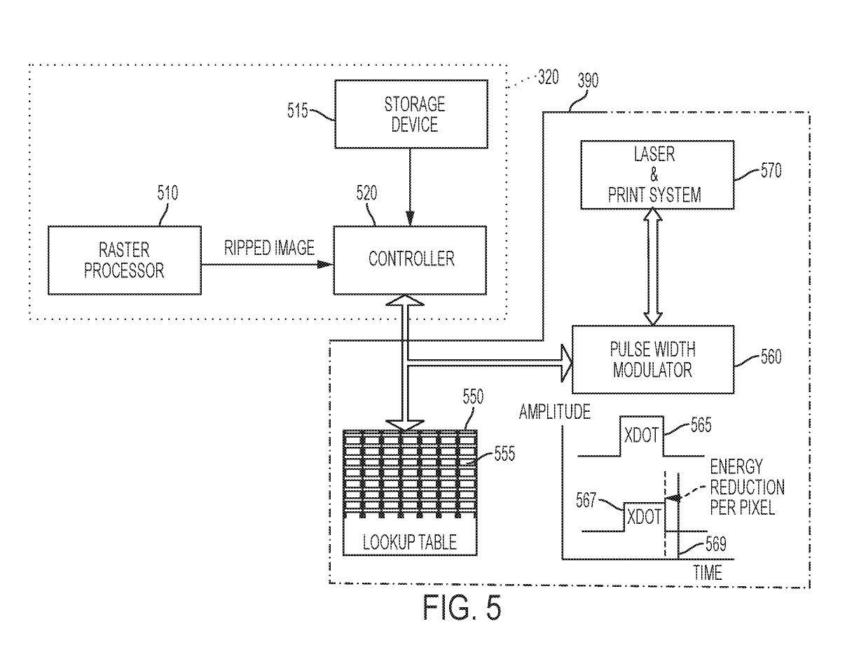

Having thus outlined several embodiments of printing apparatus and processes, and described various sequences of operation, reference is now made to FIG. 5 showing a further embodiment. Unless otherwise noted, elements similar to those previously described have been given the same reference numerals and serve the same functions. FIG. 5 is a block diagram of toner reduction logic in accordance to an embodiment.

Controller 520 comprises a programmable chip, such as a field programmable gate array (FPGA), which includes logic to perform the preferred embodiment toner saving operations. The raster processor 510 generates raster data (like RIPped Image 410) from vector graphics or page description language (PDL) commands. The raster data comprises scan lines of pels, where each pel has an “on” or “off” value and location information of the pel in the scan line. Controller 520 accesses scan lines of raster data and transfer the pels to a storage device 515 such as an SRAM. Controller 520 will access data from the storage device 515 and compare the accessed pel data with values in one of a selected look-up table (LUT) 550 that were previously loaded in a LUT such as an SRAM table. The controller 520 is encoded with logic to compare accessed pel data with the LUT to determine an output value for input pel data. The controller 520 uses the LUTs to accomplish a particular type of filter operation, e.g., print quality enhancement and toner reduction. Print quality enhancement may involve edge smoothing, compensating for density, halftoning, and the like.

The LUT table 550 specify how to modify a pel based on the values 555 specified by the toner saver tag discussed in FIG. 4. A pel is modified by modifying its pulse width 567. The modified 567 or unmodified 565 pel data, i.e., pulse width, is then transferred directly from one selected LUT column or row of LUT 550 to the pulse width modulator (PWM) 560 to generate an electronic pulse, i.e., voltage, which controls the laser beam 570 to electrically charge the area of the photoreceptor layer (roller 170) corresponding to the pel as part of the printing process as discussed in FIG. 2.

In the case where a laser emission time is controlled to be a percentage (%) of the reference emission time 565, a resultant laser emission time 567 for creating one dot is as shown. As a result, a latent image potential on the photosensitive layer of roller 170 is changed to provide a difference 569 between the exposure potentials, thus changing an amount of toner consumption. In preferred embodiments, the PWM 560 is capable of generating different pulse widths (565 or 567) for a pel having a value of “on” based on a desired level of toner saving. As noted earlier the energy reduction 569 to create a latent image will reduce the toner intensity (number of toner particle used to create a single dot) for single pixel.

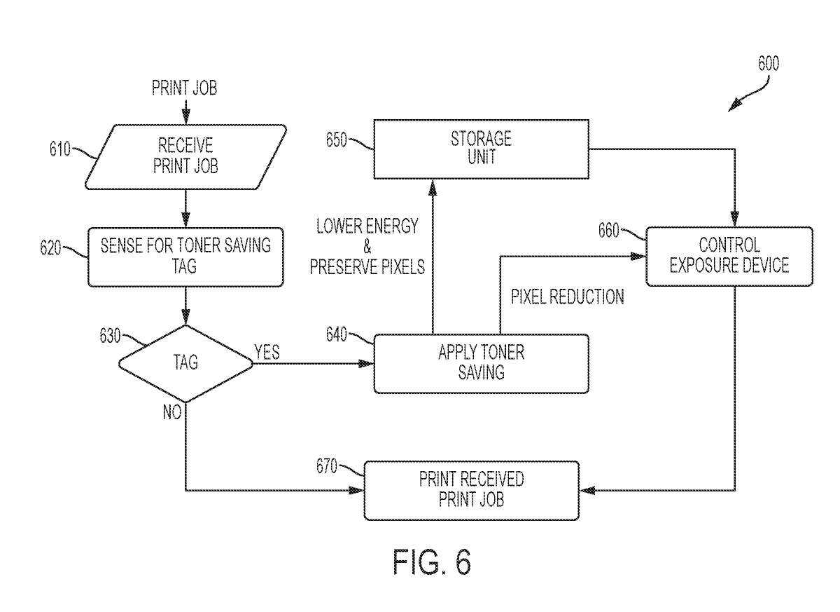

FIG. 6 is a flowchart of a method 600 for processing a toner saver tag to update the register/NVM value responsible for controlling energy applied to an imaging member in accordance to an embodiment. Process 600 begins with action 610 by receiving the print job. In action 620 the received print job is inspected to determine if a toner saver tag is embedded in the print job. In action 630, method 600 determines the action to take if a tag is found in the received print job. If there is no toner saver tag or after control modifications are done on the exposure device such as energy reduction by controlling the pulse width modulator with a modified pulse width printing the received job is initiated in action 670. In action 640, method 600 type of toner saving is determined when a toner saver tag is identified; a first type toner saver can be lowering the applied energy and preserving pixels by updating the values in storage unit 650. A second type of toner saver is applying post-processing which results in pixel reduction. A third toner save could be a combination vale updating and post-processing.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for reducing toner consumption in a printing system, the method comprising:
using a storage unit with an output value for different patterns of pixel data, where each output value indicates a pulse width power to charge a region of an image bearing member at the printing system;
receiving a print job into the printing system comprising a processor, the processor being specialized for processing image data, the print job comprising an image;
sensing whether a tag that represents a toner saving mode is embedded in the image;
wherein the tag is added to the print job during creation of a document forming the print job, added to the print job by a document manager, or added to the print job by a user using a local user interface at the print system;
in response to the embedded tag, then automatically updating the output value for different patterns of pixel data in the storage unit; and
controlling an exposure device using the output value for different patterns of pixel data in the storage unit to create at least one latent image at the image bearing member;
wherein controlling the exposure device reduces applied energy to create the at least one latent image while maintaining number of pixels of the received image.

2. The method according to claim 1, wherein the receiving the print job further comprising:
receiving a PDL file;
parsing the PDL file; and
identifying embedded coded symbology from the PDL file.

3. The method according to claim 2, wherein the output value is an exposure time or luminous energy of the exposure device.

4. The method according to claim 3, wherein the tag is at least one of a barcode, a glyph, text, an image, and coded symbology.

5. (canceled)

6. The method according to claim 1, wherein the controlling is performed by a pulse controller connected to the storage unit to control a pulse width of a laser scanning unit to adjust the energy applied to the image bearing member.

7. The method according to claim 6, further comprising:
in response to the embedded tag, then automatically applying toner saving post-processing to the print job.

8. The method according to claim 7, wherein applying toner saving post-processing is scaling and generating a mask for a selected level of toner saving on the image to produce a resultant image.

9. The method according to claim 8, further comprising:
using the resultant image and the output value in the storage unit to create the latent image at the image bearing member;
wherein a created latent image from the resultant image requires less pixels than the received image in the print job.

10. A multifunction device comprising:
a control system comprising a processor, said processor comprising a digital image processor;
a user interface connected to said control system; and
an image output device connected to said processor, said user interface providing user selection of a level of toner savings for said image output device, said processor receiving digitized pixels for an image comprising color planes of different colors, said digitized pixels comprising continuous image data,
said digital image processor applying based on user selection post-processing to said digitized pixels of said continuous image data and/or applying based on an indicia on the image a reduction in overall toner usage by lowering the energy applied to create a latent image by:
using a storage unit with an output value for different patterns of pixel data, where each output value indicates a pulse width power to charge a region of an image bearing member;
sensing whether a tag that represents a toner saving mode is embedded in the image;
wherein the tag is added to the print job during creation of a document forming the print job, added to the print job by a document manager, or added to the print job by a user using a local user interface at the print system;
in response to the embedded tag, then automatically updating the output value for different patterns of pixel data in the storage unit; and
controlling an exposure device using the output value for different patterns of pixel data in the storage unit to create at least one latent image at the image bearing member;
wherein controlling the exposure device reduces applied energy to create the at least one latent image while maintaining number of pixels of the received image.

11. The multifunction device according to claim 10, wherein receiving the digitized pixels for an image further comprising:
receiving a PDL file;
parsing the PDL file; and
identifying embedded coded symbology from the PDL file.

12. The multifunction device according to claim 11, wherein the output value is an exposure time or luminous energy of the exposure device.

13. The multifunction device according to claim 12, wherein the tag is at least one of a barcode, a glyph, text, an image, and coded symbology.

14. (canceled)

15. The multifunction device according to claim 10, wherein the controlling is performed by a pulse controller connected to the storage unit to control a pulse width of a laser scanning unit to adjust the energy applied to the image bearing member.

16. The multifunction device according to claim 15, wherein the post-processing is automatically applying halftone reduction screen to the digitized pixels.

17. The multifunction device according to claim 16, wherein the halftone reduction screen is scaling and generating a mask for a selected level of toner saving on the image to produce a resultant image.

18. The multifunction device according to claim 17, further comprising:
using the resultant image and the output value in the storage unit to create the latent image at the image bearing member;
wherein a created latent image from the resultant image requires less pixels than the received digitized pixels.

19. A non-transitory computer-readable medium storing computer-readable instructions which, when executed by a processor, cause the processor to execute toner consumption reduction in a printing system, comprising:
displaying user selective levels of toner savings for said printing system at a user interface connected to said processor; and
using a storage unit with an output value for different patterns of pixel data, where each output value indicates a pulse width power to charge a region of an image bearing member at the printing system;
receiving a print job comprising an image, wherein the print job is received as a PDL file;
sensing whether a tag that represents a toner saving mode is embedded in the image;
wherein the tag is added to the print job during creation of a document forming the print job, added to the print job by a document manager, or added to the print job by a user using a local user interface at the print system;
automatically updating the output value for different patterns of pixel data in the storage unit in response to the embedded tag;
automatically applying based on user selection post-processing to the image in the print job; and
controlling an exposure device using the output value for different patterns of pixel data in the storage unit to create at least one latent image at the image bearing member;
wherein the output value is an exposure time or luminous energy of the exposure device;
wherein the tag is at least one of a barcode, a glyph, text, an image, and coded symbology;
wherein the controlling is performed by a pulse controller connected to the storage unit to control a pulse width of a laser scanning unit to adjust the energy applied to the image bearing member;
wherein the post-processing is scaling and generating a mask for a selected level of toner saving on the image to produce a resultant image.

20. The non-transitory computer-readable medium storing computer-readable instructions according to claim 19, the processor further executing toner consumption reduction in a printing system by:
using the resultant image and the output value in the storage unit to create the latent image at the image bearing member;
wherein a created latent image from the resultant image requires less pixels than the received digitized pixels.
